(19) United States
(12) Patent Application Publication
(10) Pub. No.: US 2017/0060128 A1
(43) Pub. Date: Mar. 2, 2017

(54) MULTI-MODE REMOTE CONTROL FLYING SYSTEMS

(71) Applicant: Darren Matloff, Houston, TX (US)

(72) Inventor: Darren Matloff, Houston, TX (US)

(21) Appl. No.: 15/247,502

(22) Filed: Aug. 25, 2016

Related U.S. Application Data
(60) Provisional application No. 62/210,236, filed on Aug. 26, 2015.

(51) Int. Cl. G05D 1/00; G06F 3/038; G06F 3/0338; G08C 17/02; B64C 39/02

(52) U.S. Cl. CPC G05D 1/0016; G08C 17/02; B64C 39/024; G06F 3/0338; G06F 3/0383; G06F 3/02

(57) ABSTRACT

The disclosure herein provides dynamically configurable remote control unit systems, methods, and devices. A dynamically configurable controller comprises: a transmitter configured to transmit a control signal for receipt by a flying device, the control signal comprising data for operating a plurality of flight control channels of the flying device; a plurality of input controls configured for manipulation by a user to control a plurality of input channels; a computer processor configured to generate the control signal based at least in part on manipulations of the plurality of input controls; and at least one control mode input configured to enable the user to switch the dynamically configurable controller between first and second control modes.

### CROSS-REFERENCE TO RELATED APPLICATIONS

This application claims the benefit of U.S. Provisional Application No. 62/210,236, filed Aug. 26, 2015. The foregoing application is hereby incorporated by reference herein in its entirety.

### BACKGROUND

Field

The disclosure relates generally to the field of multi-mode remote control flying systems, and more particularly, systems and methods for a remote control capable of changing the remote control's signal output configuration with specific user input comprising multiple control modes that are used to remotely pilot a flying device, such as a quadcopter, or drone.

Description

Remote control toys are commonly used for enjoyment and other purposes. Various remote control airplanes, helicopters, quadcopters, and the like are available on the market. With increasing miniaturization of electronics and development of new battery and motor technologies, such toys have become cheaper to manufacture, more reliable, and more popular. Some such devices are even making their way into commercial and other non-toy uses, such as for aerial photography, search and rescue, package delivery, and the like.

Some remote control flying devices are easier to learn and operate than others. For example, remote-controlled airplanes are typically easier to learn to fly than a collective pitch remote-controlled helicopter. With the exploding popularity of remote-controlled flying devices, particularly quadcopters and similar devices (sometimes referred to as drones), it is desirable to enable beginners and novices to more easily get into the hobby and/or learn how to fly such a device.

### SUMMARY

The disclosure herein provides systems, methods, and devices that enable a user to operate a remotely controlled flying device using one of a plurality of selectable control modes. For example, in some embodiments, a remote control unit for controlling a four channel quadcopter comprises a beginner mode and an expert mode. In the expert mode, four user input channels of a remote control unit are mapped to four corresponding flight control channels of the quadcopter. In the beginner mode, at least one of the user input channels is disabled, and at least one flight control channel can be remapped to a different user input channel.

According to some embodiments, a dynamically configurable multi-mode controller for wirelessly operating a flying device or toy comprises: a housing sized to be held by a human hand; a transmitter configured to transmit a control signal for receipt by the flying device, the control signal comprising data for operating a plurality of flight control channels of the flying device; a plurality of input controls movably coupled to the housing and configured for manipulation by a user to control a plurality of input channels; a computer processor configured to generate the control signal based at least in part on manipulations of the plurality of input controls, and at least one control mode input configured to enable the user to switch the dynamically configurable controller between first and second control modes, wherein, in a first control mode, the computer processor maps the plurality of input channels to the plurality of flight control channels using a first mapping, and wherein, in a second control mode, the computer processor maps the plurality of input channels to the plurality of flight control channels using a second mapping different than the first mapping.

In some embodiments, the first mapping comprises associating each of the plurality of input channels with a corresponding flight control channel, and the second mapping comprises not associating at least one of the plurality of input channels with a corresponding flight control channel. In some embodiments, the first mapping comprises associating a first input channel with a first flight control channel, and the second mapping comprises associating the first input channel with a second flight control channel. In some embodiments, the first mapping comprises associating a first input channel with a first flight control channel and associating a second input channel with a second flight control channel, and the second mapping comprises associating the first input channel with the second flight control channel and not associating the second input channel with any flight control channel. In some embodiments, the plurality of input controls comprises a control stick moveable in at least horizontal and vertical directions with reference to the housing, wherein movement in the horizontal direction is associated with a first input channel, and movement in the vertical direction is associated with a second input channel. In some embodiments, the multi-mode controller further comprises: at least one control mode button configured to enable the user to switch the multi-mode controller between the first and second control modes. Instead of a button, the device may also use a switch. Additionally, although only two mappings are discussed, a remote control can have programmed more than two modes (for example, to mirror the mappings for right-handed versus left-handed users, as well as adjust the mappings for novice and expert users).

In some embodiments, the multi-mode controller further comprises: a speed mode indicator configured to provide an indication to the user of a present speed mode of the controller, wherein, in the first control mode, the speed mode indicator is configured to use a first method of providing the indication of the present speed mode, and wherein, in the second control mode, the speed mode indicator is configured to use a second method different than the first method of providing the indication of the present speed mode. In some embodiments, the speed mode indicator comprises a plurality of lights arranged in a line, wherein the first method of providing the indication of the present speed mode comprises lighting one or more of the plurality of lights beginning at a first end of the line, and wherein the second method of providing the indication of the present speed mode comprises lighting one or more of the plurality of lights beginning at a second end of the line.

In some embodiments, a non-transitory computer-readable storage medium has an executable program stored thereon, wherein the program instructs a dynamically configurable multi-mode controller to perform the following: receive one or more signals from a plurality of input controls configured for manipulation by a user to control a plurality of input channels, wherein at least one control mode input is configured to switch the dynamically configurable controller between a first control mode and a second control mode, wherein, in the first control mode, the computer processor maps the plurality of input channels to the plurality of flight control channels using a first mapping, and wherein, in the second control mode, the computer processor maps the plurality of input channels to the plurality of flight control channels using a second mapping different than the first mapping; process the received signal; generate a control signal based at least in part on manipulations of the plurality of input controls or processed signal; and transmit a control signal for receipt by a flying device, wherein the control signal comprising data for operating a plurality of flight control channels of the flying device.

In some embodiments, the program further instructs the multi-mode controller by specifying that the first mapping comprises associating each of the plurality of input channels with a corresponding flight control channel, and the second mapping comprises not associating at least one of the plurality of input channels with a corresponding flight control channel. In some embodiments, the program further instructs the multi-mode controller by specifying that the first mapping comprises associating a first input channel with a first flight control channel, and the second mapping comprises associating the first input channel with a second flight control channel. In some embodiments, the program further instructs the multi-mode controller by specifying that the first mapping comprises associating a first input channel with a first flight control channel and associating a second input channel with a second flight control channel, and the second mapping comprises associating the first input channel with the second flight control channel and not associating the second input channel with any flight control channel.

In some embodiments, the program further instructs the multi-mode controller by specifying that the plurality of input controls comprises a control stick moveable in at least horizontal and vertical directions, wherein movement in the horizontal direction is associated with a first input channel, and movement in the vertical direction is associated with a second input channel. In some embodiments, the program to further indicate to the user of a present speed mode of the controller, wherein, in the first control mode, the speed mode indicator is configured to use a first method of providing the indication of the present speed mode, and wherein, in the second control mode, the speed mode indicator is configured to use a second method different than the first method of providing the indication of the present speed mode. Additionally, the program to further indicate to the user of the present speed mode is done by using a plurality of lights arranged in a line, wherein the first method of providing the indication of the present speed mode comprises lighting one or more of the plurality of lights beginning at a first end of the line, and wherein the second method of providing the indication of the present speed mode comprises lighting one or more of the plurality of lights beginning at a second end of the line.

In some embodiments, a computer-implemented method instructs a dynamically configurable multi-mode controller to perform the following: as implemented by one or more computing devices configured with specific computer-executable instructions, receive one or more signals from a plurality of input controls configured for manipulation by a user to control a plurality of input channels, wherein at least one control mode input is configured to switch the dynamically configurable controller between a first control mode and a second control mode; wherein, in the first control mode, the computer processor maps the plurality of input channels to the plurality of flight control channels using a first mapping; and wherein, in the second control mode, the computer processor maps the plurality of input channels to the plurality of flight control channels using a second mapping different than the first mapping; process the received signal; generate a control signal based at least in part on manipulations of the plurality of input controls or processed signal; and transmit a control signal for receipt by a flying device, wherein the control signal comprising data for operating a plurality of flight control channels of the flying device.

In some embodiments, the method further specifies that the first mapping comprises associating each of the plurality of input channels with a corresponding flight control channel, and the second mapping comprises not associating at least one of the plurality of input channels with a corresponding flight control channel. In some embodiments, the method further specifies that the first mapping comprises associating a first input channel with a first flight control channel, and the second mapping comprises associating the first input channel with a second flight control channel. In some embodiments, the method further specifies that the first mapping comprises associating a first input channel with a first flight control channel and associating a second input channel with a second flight control channel, and the second mapping comprises associating the first input channel with the second flight control channel and not associating the second input channel with any flight control channel.

According to some embodiments, a non-transitory computer-readable storage medium has an executable program stored thereon for causing a suitably programmed dynamically configurable controller to process by one or more processors computer program code by performing a method for wirelessly operating a flying device when the computer program code is executed by the dynamically configurable controller, the method comprising: detecting a plurality of user inputs corresponding to movement of one or more input controls relative to a housing of the dynamically configurable controller, the controller comprising a plurality of input channels, and the plurality of user inputs each being associated with a respective input channel; determining a present control mode of the dynamically configurable controller; mapping the plurality of input channels to the plurality of flight control channels using a first mapping based on the determined present control mode; generating a control signal comprising data for causing operation of the flying device, the control signal based at least in part on the mapping of the plurality of input channels to the plurality of flight control channels; transmitting the control signal for receipt by the flying device; detecting activation of a control mode input; changing the present control mode of the dynamically configurable controller, responsive to detecting the control mode input; and mapping the plurality of input channels to the plurality of flight control channels using a second mapping different than the first mapping, responsive to the change in present control mode.

In some embodiments, the first mapping comprises associating each of the plurality of input channels with a corresponding flight control channel, and the second mapping comprises not associating at least one of the plurality of input channels with a corresponding flight control channel. In some embodiments, the first mapping comprises associating a first input channel with a first flight control channel, and the second mapping comprises associating the first input channel with a second flight control channel. In some embodiments, the first mapping comprises associating a first input channel with a first flight control channel and associating a second input channel with a second flight control channel, and the second mapping comprises associating the first input channel with the second flight control channel and not associating the second input channel with any flight control channel. In some embodiments, the one or more input controls comprises a control stick moveable in at least horizontal and vertical directions, wherein movement in the horizontal direction is associated with a first input channel, and movement in the vertical direction is associated with a second input channel. In some embodiments, the method further comprises: indicating to the user a present speed mode of the controller, wherein, in a first control mode, the speed mode indicator is configured to use a first method of providing the indication of the present speed mode, and wherein, in a second control mode, the speed mode indicator is configured to use a second method different than the first method of providing the indication of the present speed mode. In some embodiments, the indication to the user of the present speed mode is performed by using a plurality of lights arranged in a line, wherein the first method of providing the indication of the present speed mode comprises lighting one or more of the plurality of lights beginning at a first end of the line, and wherein the second method of providing the indication of the present speed mode comprises lighting one or more of the plurality of lights beginning at a second end of the line.

According to some embodiments, a computer-implemented method of wirelessly operating a flying device using a dynamically configurable controller comprises: detecting a plurality of user inputs corresponding to movement of one or more input controls relative to a housing of the dynamically configurable controller, the controller comprising a plurality of input channels, and the plurality of user inputs each being associated with a respective input channel; determining a present control mode of the dynamically configurable controller; mapping the plurality of input channels to the plurality of flight control channels using a first mapping based on the determined present control mode; generating a control signal comprising data for causing operation of the flying device, the control signal based at least in part on the mapping of the plurality of input channels to the plurality of flight control channels; transmitting the control signal for receipt by the flying device; detecting activation of a control mode input; changing the present control mode of the dynamically configurable controller, responsive to detecting the control mode input; and mapping the plurality of input channels to the plurality of flight control channels using a second mapping different than the first mapping, responsive to the change in present control mode.

In some embodiments, the first mapping comprises associating each of the plurality of input channels with a corresponding flight control channel, and the second mapping comprises not associating at least one of the plurality of input channels with a corresponding flight control channel. In some embodiments, the first mapping comprises associating a first input channel with a first flight control channel, and the second mapping comprises associating the first input channel with a second flight control channel. In some embodiments, the first mapping comprises associating a first input channel with a first flight control channel and associating a second input channel with a second flight control channel, and the second mapping comprises associating the first input channel with the second flight control channel and not associating the second input channel with any flight control channel. In some embodiments, the one or more input controls comprises a control stick moveable in at least horizontal and vertical directions, wherein movement in the horizontal direction is associated with a first input channel, and movement in the vertical direction is associated with a second input channel.

At least one benefit in switching modes quickly and in mid-flight can allow the operator of a remote-controlled flying vehicle account for flying in varying environments or situations. For example, an operator of intermediate skill may be controlling an air vehicle and flying it between buildings where wind speed may increase and the user may opt to change flying modes to make flying through the wind easier. In another example, an operator may want to hand the remote control to another operator with a different skill level and would want to change the button mapping). In either example, and in many others, the relatively quick ability to change button mappings allows operators of varying skill levels significant flexibility to fly a remote controlled air vehicle in varied environments (for example, temperature, wind, moisture, and more) in varied circumstances (for example, the vehicle may be carrying a heavy load, be designed with a unique weight distribution while flying, or the vehicle may be relatively large or small).

### BRIEF DESCRIPTION OF THE DRAWINGS

The foregoing and other features, aspects, and advantages of the present disclosure are described in detail below with reference to the drawings of various embodiments, which are intended to illustrate and not to limit the disclosure. The drawings comprise the following figures in which:

FIG. 1A illustrates an embodiment of a remote control capable of controlling a flying toy as well as user input and flight control channel mappings in two different flight control modes.

FIG. 1B illustrates several blown up illustrations of various parts of the remote control as depicted in FIG. 1A.

FIG. 2A illustrates an embodiment of a flying toy that can be controlled by the remote control as depicted in FIG. 1A.

FIG. 2B illustrates an embodiment of a flying toy that can be controlled by the remote control as depicted in FIG. 1A and also shows the location of other components.

FIG. 2C illustrates an embodiment of a flying toy that can be controlled by the remote control as depicted in FIG. 1A and also shows the possible flight directions that may be controlled.

FIG. 3A illustrates an embodiment of various mappings of the remote control as depicted in FIG. 1A and how the mappings change between two of the configured modes.

FIG. 3B illustrates another embodiment of various mappings of the remote control as depicted in FIG. 1A and how the mappings change between two of the configured modes.

FIG. 4 illustrates an embodiment of methods for performing computer controlled stunt rolls by a flying toy, for example, a quadcopter.

FIG. 5 illustrates an embodiment of a block diagram of a remote control unit in communication with a flying toy.

FIG. 6 illustrates another embodiment of a block diagram of a remote control unit in communication with a flying toy.

FIG. 7 illustrates an embodiment of a block diagram of a flying toy, for example a quadcopter.

FIG. 8 illustrates a flow chart diagram of one embodiment of the process that a remote control unit would take generating and transmitting a signal to a flying toy.

FIG. 9 illustrates a flow chart diagram of one embodiment of the steps that a flying toy would take upon receipt to process and execute a signal.

### DETAILED DESCRIPTION OF THE EMBODIMENTS

Although several embodiments, examples, and illustrations are disclosed below, it will be understood by those of ordinary skill in the art that the disclosure described herein extends beyond the specifically disclosed embodiments, examples, and illustrations and includes other uses of the disclosure and obvious modifications and equivalents thereof. Embodiments of the disclosure are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the disclosure. In addition, embodiments of the disclosure can comprise several novel features and no single feature is solely responsible for its desirable attributes or is essential to practicing the disclosures herein described.

The disclosure herein provides systems, methods, and devices that enable operation of a remotely controlled device using a plurality of dynamically selectable control modes or configurations. In some embodiments, a remote-controlled toy system comprises a flying device, such as a quadcopter, and a remote control unit configured for operation by a user to control the flight of the quadcopter. In some embodiments, the quadcopter comprises four flight control channels, namely, throttle, pitch, yaw, and roll. In some embodiments, the remote control unit also comprises four user input channels, with each of the four user input channels operable independently to control the four flight control channels. For example, as will be described in greater detail below, the remote control unit may comprise two control sticks, with each control stick providing an input mechanism for two user input channels (for example, one user input channel based on a horizontal position of the control stick, and a second user input channel based on a vertical position of the control stick). The remote control unit may comprise a processor that is configured to map those four user input channels to appropriate flight control channels of the quadcopter.

In some embodiments, the remote control unit may be configured to enable dynamic reconfiguration of the mappings of user input channels to flight control channels while a remotely controlled device, such as a drone, is in the air and being controlled by the remote control unit. It may be desirable, such as when an operator wants to have a different level of control of a device and/or is preparing to perform a particular maneuver, to enable quick and dynamic remapping of user input channels to flight control channels while a flying device is in the air. Accordingly, some embodiments disclosed herein comprise one or more easily accessible user interface features, such as a button, toggle switch, and/or the like, that enable quick selection of different control modes during flight. In some embodiments, such a user interface feature is positioned on the controller in a position that enables the user to operate the feature by moving a single finger, without otherwise repositioning the user's hands or removing the user's hands from a normal operating grip. In some embodiments, the re-configurability of the remote control mappings during flight is configured to be quick enough and easy enough that the change can take place in real time or substantially in real time without the operator losing control of the flying device and/or requiring the operator to take his or her eyes off of the flying device.

Various control configurations can be used in remote controls for quadcopters. One configuration, as discussed in greater detail below, is for the left joystick to have the throttle on the vertical channel and yaw on the horizontal channel, and for the right joystick to have pitch on the vertical channel and roll on the horizontal channel. It can be desirable, however, to enable dynamic changes to be made to such a configuration (for example, mapping a flight control channel to a different input channel, disabling an input and/or flight control channel, and/or the like), and the various embodiments disclosed herein enable such dynamic changes.

For an expert pilot, or operator, of quadcopters, the user may desire full control of the quadcopter, meaning independent control of each of the four flight control channels. Accordingly, an expert mode may comprise each of the four user input channels being mapped to a flight control channel. For a beginner, however, it may be easier for the user to learn how to fly the quadcopter if the user does not have to control each of the flight control channels. Accordingly, in some embodiments, the remote control unit is configured to comprise a beginner mode in which at least one of the user input channels or flight control channels is disabled or ignored. If a user only needs to control three flight control channels instead of four, it can be easier for the user to learn to fly the quadcopter. Preferably, the roll flight control channel (and/or its corresponding user input channel) would be disabled or ignored in beginner mode. For example, if roll is disabled, then an operator would only need to handle control of three channels (the throttle, pitch, and yaw flight control channels) and would still be able to fly the aircraft using those three channels. Although disabling of the roll channel is presently discussed, various other embodiments may have additional and/or different channels disabled.

Further, it can be easier for a beginner to learn to fly a quadcopter if the user input channels are mapped to the flight control channels in a different way than in the expert mode. For example, it may be desirable in a beginner mode to enable one control stick to operate nothing but the throttle, and the other control stick to operate two other flight control channels. Since precision throttle control is one of the hardest flight control concepts to learn, it can be desirable to move a flight control channel that otherwise in expert mode would be linked to the same joystick as the throttle to another stick. Further details of such an embodiment are described below. However, it is important to note that, in some embodiments, changing the mapping of a user input channel(s) may not be required or preferred, because, for example, throttle may already be on its own joystick in some embodiments.

As an operator progresses from beginner to expert, it can be desirable to enable the user to easily switch back and forth between the beginner and expert modes while the drone is in flight. For example, a user may start a flight in beginner mode and, once the drone is at a sufficient altitude such that mistakes have a lower chance of causing a crash, the user may desire to dynamically switch the control mode from beginner to expert mode. The user can then hone his or her flying skills in expert mode, and optionally switch back into beginner mode before landing, such as to lessen the chance of a crash when the drone comes closer to the ground.

Although various embodiments disclosed herein are described with respect to a remote control unit having two modes comprising a beginner mode and expert mode, various other embodiments may have two or more dynamically selectable modes that cause a remapping and/or disabling of certain user input and/or flight control channels for purposes other than accommodating a beginner or expert user. For example, some flight maneuvers may be easier to perform with a mapping of user input channels to flight control channels that is different than the normal mapping utilized for normal flight. As another example, a particular flight maneuver may be adversely affected by accidental user inputs on a particular channel. For example, in a case where the right joystick of a remote control comprises the vertical axis mapped to the pitch flight control channel and the horizontal axis mapped to the roll flight control channel, an inadvertent horizontal movement of the joystick may cause a crash if a user is attempting a difficult maneuver, such as a 360° forward flip of the drone about its pitch axis. In such a case, it may be desirable to, for example, temporarily disable the roll flight control channel, to ensure any inadvertent horizontal motion of the joystick does not cause an undesirable rolling motion of the aircraft during the forward flip.

In some embodiments, instead of completely disabling a particular user input channel or flight control channel, the system may be configured to create or increase dead space in the user input for that channel. For example, some remote control devices may be configured such that a joystick has to be moved away from its central or home position by a predetermined threshold amount before that joystick movement will be registered or interpreted as a request by the user to adjust the associated flight control channel. By adding such dead space to a particular user input channel (or increasing the threshold value of an existing dead space) a remote control unit can be configured to lessen the impact of inadvertent joystick movements without completely disabling that particular input or flight control channel.

It should be noted that, when the term flight control channels is used herein, it is used to refer to high level flight controls, such as throttle, pitch, roll, and yaw, not low level individual control of each motor, flight control surface, and/or the like.

Various embodiments disclosed herein are described with respect to a quadcopter. The techniques disclosed herein, however, may be utilized with any remotely controlled flying device (for example, airplane, drone, helicopter, hexacopter, blimp, and/or the like), or even a remotely controlled ground vehicle (for example, car, truck, and/or the like), boat, and/or the like, as long as the remotely controlled device comprises more than one control channel. Further, although reference is made throughout this disclosure to remote control toys, the concepts disclosed herein are not limited to the use of such remote controlled devices as toys. For example, the systems and methods disclosed herein may be used with professional level flying devices or other remotely controlled devices, such as, for example, drones used in professional photography, package delivery, military training, competitive racing, and/or the like.

### Multi-Mode Remote Control Unit

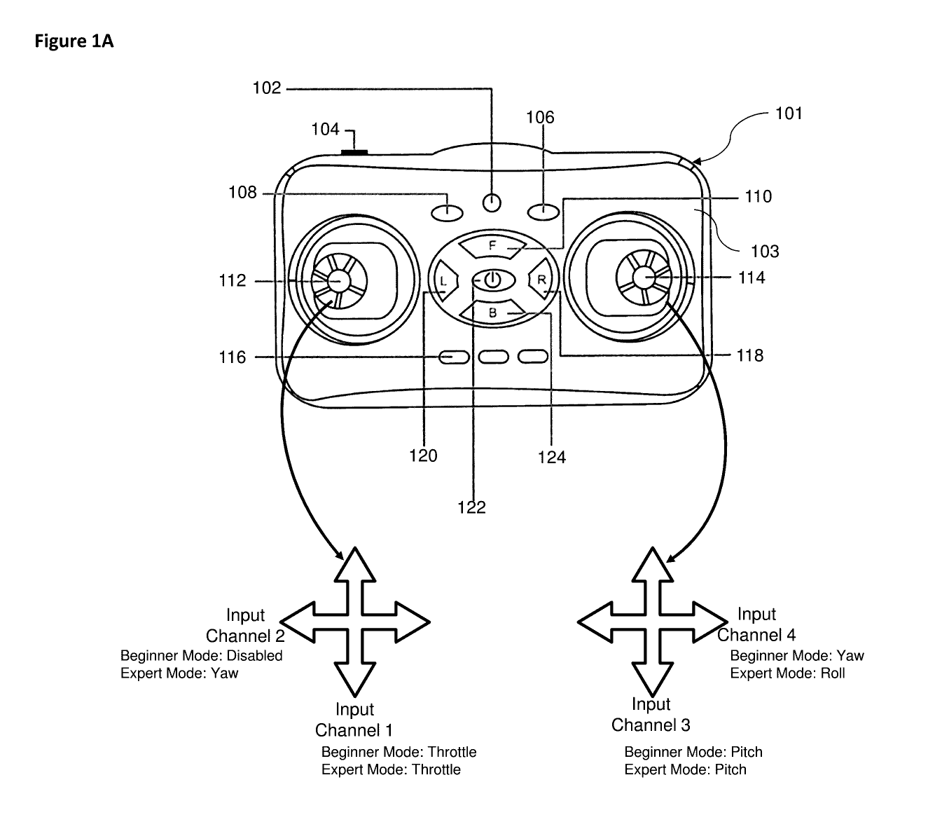

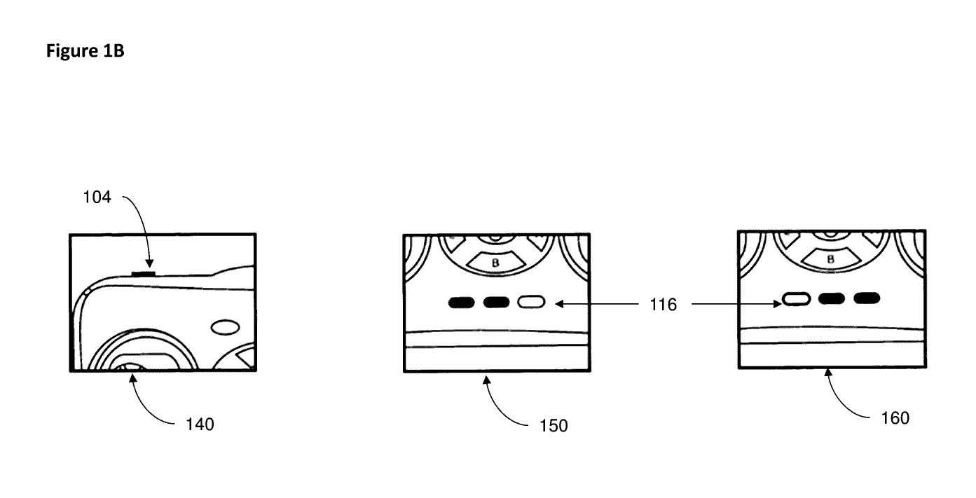

FIG. 1A illustrates one embodiment of remote control capable of controlling a flying toy as well as user input and flight control channel mappings in two different flight control modes. The remote control unit 101 illustrated in FIG. 1A comprises a housing 103 having two primary flight control joysticks, namely a left stick 112 and a right stick 114, coupled thereto. The left stick 112 is used to control input channel 1 in the vertical direction 130 and input channel 2 in the horizontal direction 126. Right stick 114 is used to control input channel 3 in the vertical direction 132 and input channel 4 in the horizontal direction 128. The remote control unit 101 further comprises a three channel mode button 108 and a four channel mode button 106. In some embodiments, the three channel mode button 108 is referred to as a beginner mode button 108 and, in other embodiments may also act as a camera snap shot button 108. In some embodiments, the four channel mode button 106 is referred to as an expert mode button 106, and in other embodiments may also act as a start and stop video recording button. For example, each button may control one function (e.g., mode switching) upon a momentary press and a different function (e.g., camera or video control) upon a sustained press, or vice versa. In some embodiments, the buttons 108, 106 are used only for mode changes. In this embodiment, the control mode buttons 106, 108 are positioned on the housing 103 near enough to the left and right control joysticks 112, 114, respectively, such that a user can quickly and easily operate the buttons 106, 108 by moving one of his or her thumbs from a joystick to a button without otherwise changing his or her grip on the housing 103. This positioning can be desirable to enable the user to continue controlled flight of the flying device, without losing control of the flying device during the mode-change process. In other embodiments, the buttons 106, 108 may be positioned at other easily accessible locations, such as at the top or back of the housing 103, to enable a different finger of the user to operate the button while the user keeps his or her thumbs on the joysticks 112, 114.

In this embodiment, each of the buttons 106, 108 is configured to enable quick access to an operating mode or flight control channel mapping associated with that button. In other embodiments, other methods of quick access to such modes may be used, such as, for example, a single button that toggles through two or more modes upon successive presses of the button, a toggle switch having two or more positions, a slider having two or more positions, a touchscreen user interface having functionality to enable switching of modes by a user, and/or the like.

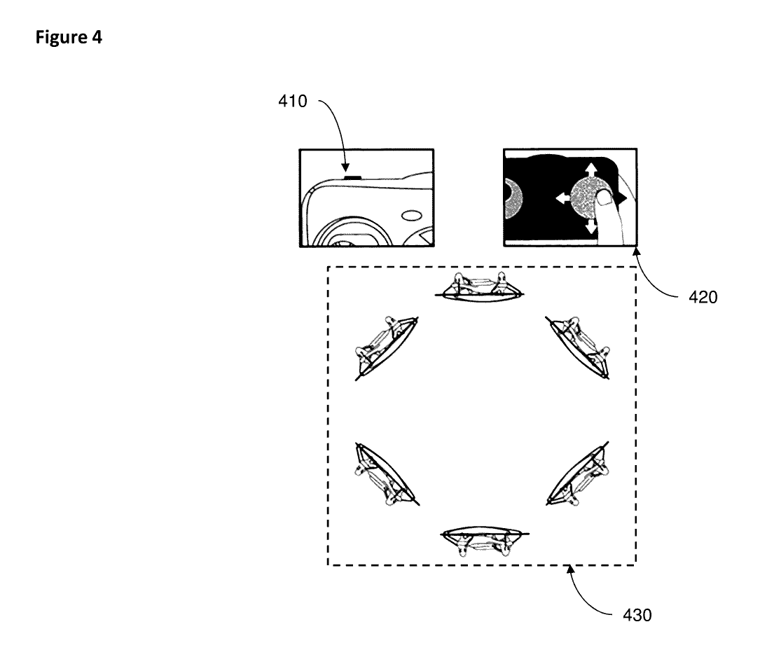

The remote control unit 101 also comprises: a power indicator light 102 to indicate to a user of the controller whether or not the remote control is powered on; a stunt roll or speed button 104 that allows a user to press and hold the button, or just press the button in some embodiments, to turn the mode on and select with the right joystick, in some embodiments, which direction the device may flip towards (i.e. forward, backwards, right side, or left side roll), refer to FIG. 4 for more details on the stunt roll button 104 (referred to as 410 in FIG. 4); a series of buttons used for trimming, forward trim 110, left bank trim 120, backward trim 124, and right bank trim 118, such that if the quadcopter does not fly straight, the trim buttons may be used to adjust the stability of the flight; and a speed indicator light 116 which can indicate to the user which of the speed modes the remote control is operating in.

In the present embodiment in FIG. 1A, the quadcopter may have three speed modes indicated by three lights 116. These lights indicate what speed the remote control and/or flying device is operating in, such that, for example, 1 light may mean slow, two lights may mean medium, and three lights may mean high speed. The speed may affect the different maximum speeds of its motors, or alternatively, it may affect the responsiveness, or sensitivity, of the throttle control where a lower speed (in either situation) can be helpful to a beginner to learn how to control the quadcopter more easily. Additionally, in some embodiments, the indicator lights 116 can illuminate from left to right when in three channel mode, and from right to left while in four channel mode. This can help to visually show what mode the device is currently in without requiring a separate mode indicator. In other embodiments, however, a separate mode indicator (for example, one or more LED's, an indicator on an LCD display, and/or the like) may be used. Additionally, in some embodiments, the remote control 101 may comprise a speaker to indicate to a user with a series of beeps or the like when certain modes and operations are activated or changed by the user.

The bottom of FIG. 1A indicates how the user input channels are mapped to flight control channels based on what mode the remote control unit 101 is in. For example, in one embodiment, when the remote control unit 101 is in expert or four channel mode (for example, the user pressed the four channel button 106), Input Channel 1 is mapped to the throttle flight control channel, Input Channel 2 is mapped to the yaw flight control channel, Input Channel 3 is mapped to the pitch flight control channel, and Input Channel 4 is mapped to the roll flight control channel. In the beginner or three channel mode (for example, the user pressed the three channel button 108), however, Input Channel 2 is disabled, yaw is remapped from Input Channel 2 to Input Channel 4, and no input channel is mapped to the roll flight control channel. Such a configuration can help a beginning pilot to learn how to fly a quadcopter with fewer channels to think about, and by isolating the throttle flight control channel on its own flight control stick. The quick-access buttons 108, 106 can enable the user, however, to switch back and forth between the modes during flight, if desired.

With reference to FIG. 1B, and particularly diagrams 150 and 160, the speed indicator lights 116 can be used to indicate both the current speed mode and the current control mode. For example, the number of lights currently lit up can be used to illustrate the current speed mode. Further, the direction from which the lights light up may indicate the current control mode. As seen in diagram 150, the two leftmost lights are lit up, meaning the remote control unit 101 is in a medium or second speed mode, and is in beginner control mode, because the lights begin at the left side (the same side as the three channel button 108 in FIG. 1A). In diagram 160, the remote control unit 101 is still in the medium or second speed mode, because two lights are lit up, but the lights begin at the right side (the same side as the four channel button 106 in FIG. 1A), indicating that the device is in four channel or expert mode. This is merely one example of how an indicator may be utilized to provide information regarding what modes of at least two different types of modes a device is operating in.

### Flying Device

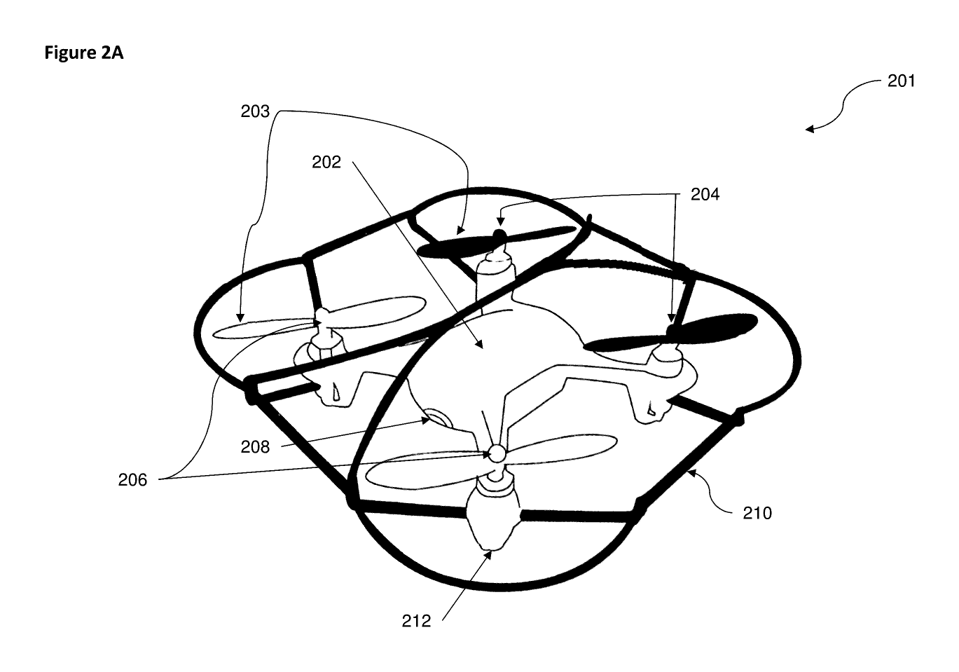

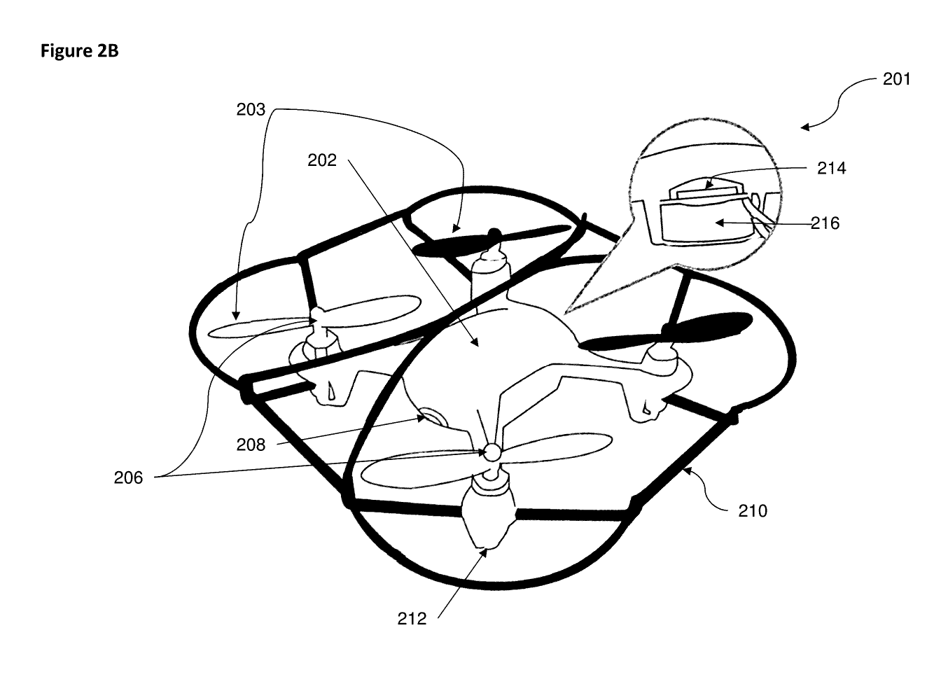

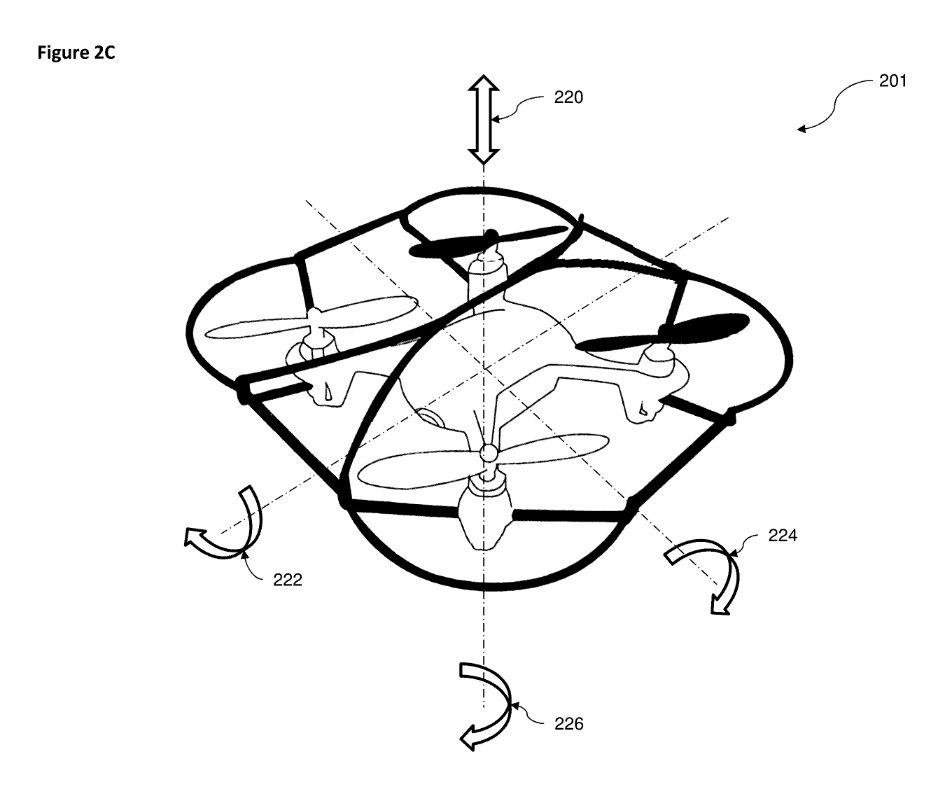

FIG. 2A illustrates an embodiment of a remotely controlled flying device or toy 201 (in this case, a quadcopter) that can be wirelessly controlled by a remote control unit 101, as depicted in FIG. 1A. Four independently controllable motors 204 operate to fly the toy 201 through the air. The flying toy 201 comprises a controller that converts high level flight control data (for example, throttle, pitch, yaw, roll, and/or the like) into low level motor control signals that operate the motors 204 and 206 to implement the desired effect of the flight control data. For example, a flight control input indicating that throttle should be increased may result in the speed of all four motors 204 and 206 being increased. The motors 204 and 206 are connected to rotor blades 203 that spin and provide lift for the quadcopter to fly. Further, a flight control input indicating that the flying toy body 202 should pitch forward or perform forward flight may result in, for example, the two rear motors 204 having their speed increased relative to the front motors 206. Additionally, in some embodiments, the quadcopter may include a camera module 208 to take pictures and record content, landing gear 212 to enable the drone to land on various surface-types; and a safety cage 210 to protect the rotor blades 203, the flying toy body 202, and any other part of the drone from damage that may result from a collision between the drone and another surface (for example, floor, tree, building, or the like).

It should be noted that, when the term flight control channels is used herein, it is used to refer to the high level controls, such as throttle, pitch, roll, and yaw, not the low level individual control of each motor. Further, although in various places herein, a flying toy is described as having four flight control channels, namely throttle, pitch, roll, and yaw, various other flight control channel configurations and/or naming conventions may be utilized without departing from the techniques disclosed herein. For example, in some embodiments, the throttle flight control channel may be referred to as an altitude channel, the pitch channel may be referred to as a forward and backward movement flight control channel, the roll flight control channel may be referred to as a bank flight control channel, and/or the yaw flight control channel may be referred to as a turn or spin flight control channel.

FIG. 2B illustrates the same embodiment of a flying toy as depicted in FIG. 2A that can be controlled by the remote control as depicted in FIG. 1A, and also shows the location of other components that can be added to the flying toy. For example, the flying toy desirably comprises a battery module 216 to operate. Optionally, the flying toy can also include a memory card slot 214 for the insertion of a memory card. The memory card may be used to record pictures or video from a corresponding camera module 206, or record additional statistics such as flight speed, battery level, servo motor position, or other data available through its sensors and internal components, which are discussed below in detail.

FIG. 2C illustrates the same embodiment of a flying toy as depicted in FIG. 2A that can be controlled by the remote control as depicted in FIG. 1A, and also shows the flight directions that may be controlled. For example, the four flight control channels that are controlled by the controller 101 in FIG. 1A can control the throttle/altitude 220, yaw 226, pitch 224, and roll 222.

### Multi-Mode Remote Control Unit and Flying Device Interaction

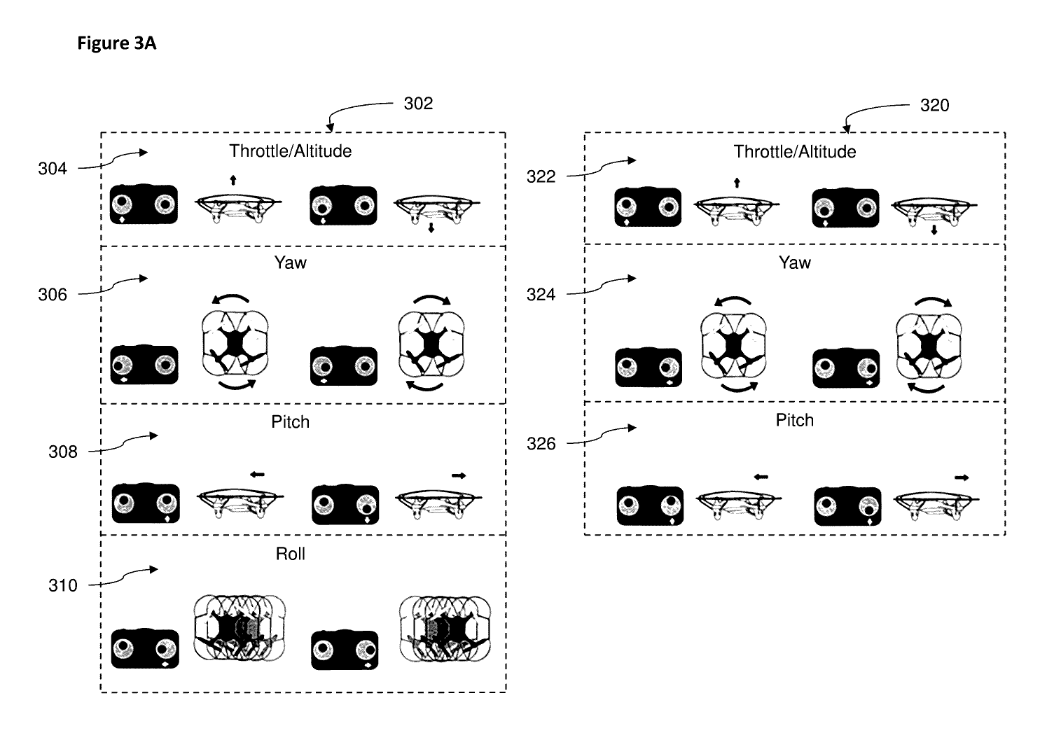

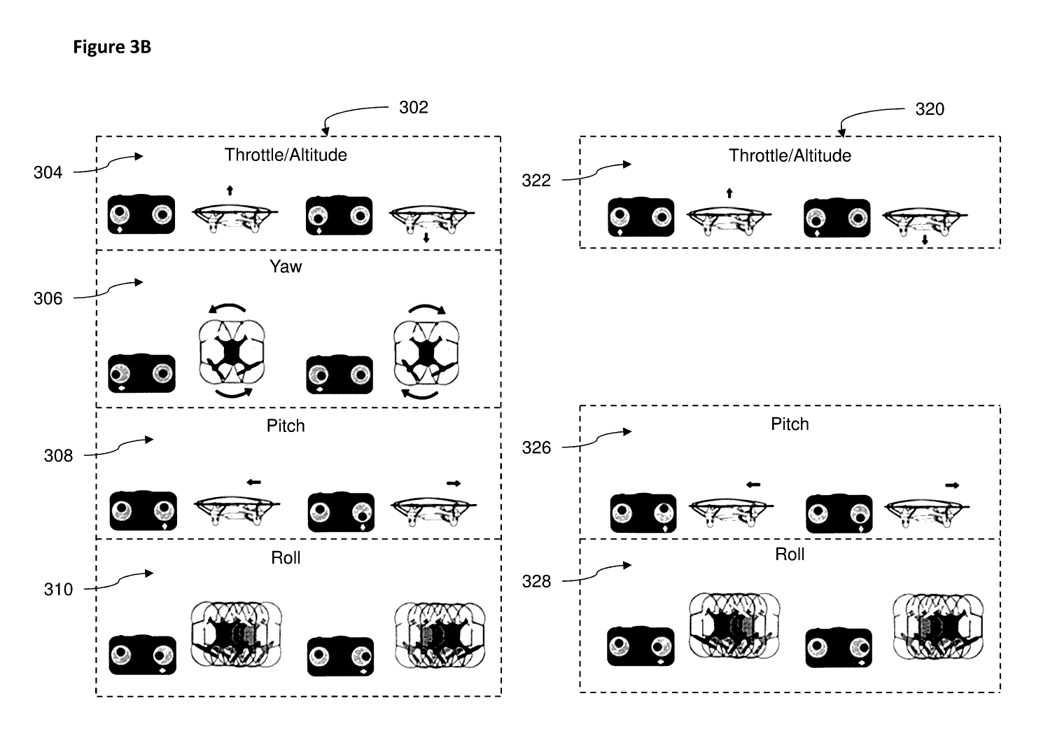

FIG. 3A illustrates an embodiment of various mappings of the remote control as depicted in FIG. 1A and how the mappings change between two of the configured modes. FIG. 3A provides more detail regarding how the input channels are mapped to flight control channels in the two control modes of the remote control unit 101 in FIG. 1A. The four channel mode 302 illustrates the input channel to flight control channel mappings in four channel or expert mode and the three channel mode 320 illustrates the input channel to flight control channel mappings in three channel or beginner mode.

In this embodiment, four channel mode 302 is, as described earlier, when the left joystick has the throttle on the vertical channel and yaw on the horizontal channel, and the right joystick has pitch on the vertical channel and roll on the horizontal channel. The throttle 304 illustrates that if a user pushed up on the left joystick then the drone will increase the power to its 4 motors and rise in elevation/altitude. Likewise, a user pushing the joystick in the down direction will decrease the power to the 4 motors and lead to a decrease in elevation/altitude of the drone. The yaw 306 illustrates that if a user pushes the left joystick to the left or right, the drone with rotate counter-clockwise and clockwise, respectively. The pitch 308 illustrates that if a user pushes the right joystick up or down the drone will lean forwards or backwards, respectively. For example, to pitch forward (pressing up on the right joystick), the drone may decrease the power to the front motors and leave the rear motors at the same power level as dictated by the throttle control. Likewise, the opposite can be applied to the rear motors to pitch forward, such that the rear motors increase power. Additionally, a combination of decreasing power to the front motors and increasing power to the rear motors may be applied at the same time to pitch forward. Lastly, to roll 310, a user can push the right joystick to the right or left to signal to the drone to lean right or left, respectively. This can be accomplished similarly to pitch 308 by signaling to the drone to apply increased or decreased throttle (or a combination) to the two motors on right or left side of the quadcopter.

In this embodiment, three channel mode 320, is depicted as showing two changes with respect to the four channel mode 302. First, one of the channels, roll 310, is ignored or disabled by the remote control. Second, yaw has been remapped from the left joystick 306 to the right joystick 324, so that throttle is the only control channel on the left joystick.

Various other embodiments may disable one or more different channels, disable no channels, remap one or more different channels, remap no channels, and/or the like. One example of such an alternative embodiment is shown in FIG. 3B. FIG. 3B illustrates another embodiment of various mappings of the remote control as depicted in FIG. 1A and how the mappings change between two of the configured modes. For example, in FIG. 3B the only change between the four channel mode 302 and the three channel mode 320 is that yaw 306 has been disabled or ignored. Also, throttle 322 remains the only control channel on the left joystick.

Returning to FIG. 1A, as mentioned above, it can be desirable to enable a remote control unit, such as remote control unit 101 to indicate to the user what control mode the control unit is in. One way of accomplishing this is to have an LED light or other indicator which lights up to indicate which mode the controller is in. To save manufacturing costs, among other things, another way to illustrate or depict the current control mode is to combine the control mode indication with a different indicator already present on the controller. For example, as shown in FIG. 1A, the remote control unit 101 comprises speed indicator lights 116 which indicate a current speed mode the remote control unit 101 and/or the flying toy 201 is in. In this case, there are three speed modes, indicated by the number of speed indicator lights 116 that are currently lit up. The speed mode may be changed, for example, by pressing speed button 104. The speed may affect the different maximum speeds of its motors, or alternatively, it may affect the responsiveness, or sensitivity, of the throttle control where a lower speed, in either situation, may be helpful to a beginner to learn how to control the quadcopter more easily. Additionally, in some embodiments, the indicator lights 116 can illuminate from left to right when in three channel mode, and from right to left while in four channel mode. Such a configuration can also make it more efficient for a user to determine what speed mode and what control mapping mode the device is currently in, without having to refer to multiple indicators. This can allow the user to focus on watching the flying device in the air, instead of spending unnecessary time looking at the remote control unit. Additionally or alternatively, in some embodiments, the remote control 101 may contain a speaker to indicate to a user with a series of beeps when certain modes and operations are activated or changed by the user.

### Other Channel Configurations

Although the embodiment illustrated in FIGS. 1-3 comprises two modes, namely a three channel mode and a four channel mode, various other embodiments may comprise more than two modes. Further, other embodiments may remap the input channels to the flight control channels differently. For example, in some embodiments, input channel 2 may be disabled, like as shown in FIG. 3A, but input channel 4 may remain mapped to the roll flight control channel instead of being remapped to the yaw flight control channel as shown in FIG. 3B.

Further, the techniques disclosed herein are not limited to a remotely controlled flying device having four flight control channels. For example, some remote control helicopters comprise less or more flight control channels. Some of the simplest helicopters may comprise two flight control channels, namely one channel for controlling throttle or the speed of the main rotor, and the second channel for controlling tail rotor speed or yaw. A three channel helicopter, for example a counter-rotating main rotors helicopter, may comprise a first channel to control throttle or overall speed of the main rotors, a second flight control channel to control yaw, such as by varying the relative speed of the counter rotating rotors, and a third channel to control pitch, such as by varying the speed of a tail fan that is positioned to blow air upward or downward. A four channel helicopter, such as a helicopter having counter rotating coaxial rotors, may comprise a first channel to control the throttle or overall speed of the main rotors, a second channel to control left and right yaw by varying the relative speed of the counter rotating rotors, a third channel to control pitch, such as by moving swash plate, and a fourth channel to control roll, such as also by controlling movement of the swash plate. As another example, another four channel helicopter, such as a single rotor fixed pitch helicopter, may comprise a first channel that controls the throttle or speed of the main rotor to control altitude, a second channel that controls yaw, such as by controlling speed or pitch of a tail rotor, a third channel the controls pitch, and a fourth channel that controls roll.

A remote control helicopter comprising a collective pitch rotor typically requires at least five flight control channels and ideally more. For a five channel collective pitch helicopter, for example, a first flight control channel may control throttle, a second channel may control tail rotor pitch or speed, a third channel may control swash plate cyclic pitch, a fourth channel may control swash plate cyclic roll, and a fifth channel may control the collective pitch of the main rotor blades. A six channel helicopter with collective pitch may, for example, utilize the sixth channel to select different gyro gain settings and/or to select between yaw rate gyro mode or heading hold gyro mode. Various additional channels may be used in some embodiments to control, for example, landing gear, fuel mixture, engine speed governor, various remote gain adjustments, return to home flight mode activation, smoke systems, navigation and/or landing lights, weapons, aerial photography and/or video controls, and/or the like.

As can be seen, there are various embodiments of remote controlled flying toys and other devices that have various numbers and configurations of flight control (or other type of control) channels. In any of these embodiments, it may be desirable to have at least two control modes, wherein the remote control unit remaps one or more user input channels to a different flight control (or other type of control) channel and/or deactivates one or more user input channels and/or flight control channels, such as to make the remote controlled flying toy easier to fly and/or easier for a beginner to learn, or to make a particular flight maneuver easier to perform. For example, with a six channel helicopter, in some embodiments, a beginner mode may deactivate the roll flight control channel, similarly to as shown in FIG. 3A, and may even deactivate additional channels, such as, for example, yaw and/or gyro gain settings. Further, in some embodiments, activation of a beginner mode may combine the throttle flight control channel with the collective pitch channel such that a single user input channel controls both flight control channels together. In some embodiments, even in an expert mode, throttle and collective pitch may be combined together, but the method of combining them, and/or the aggressiveness (or other quality) of the pitch curve may vary when the controller in a different control mode.

### Stunt Mode

FIG. 4 illustrates an embodiment of methods for performing computer controlled stunt rolls by a flying device, for example, a quadcopter. In some embodiments, a remote control and/or a flying device may comprise a computer processor configured to automatically perform a roll and/or other stunt in response to a user input indicating the requested stunt. For example, in some embodiments, holding down a stunt button 410, which is similar to the stunt button in 104 in FIG. 1A, may indicate to a remote control that the user wishes to perform a stunt, and then operation of one or more of the user input channels 420, which is similar to the user pressing on the right joystick 114 in FIG. 1A, may further indicate the particular stunt the user would like to perform. Element 430 is a depiction of what the flying toy, or in this case a drone, would look like in steps after activating a stunt. In some embodiments, the flying toy is configured to utilize an internal gyro and/or accelerometer to facilitate the stunt roll.

### Other Multi-Mode Flying Device Embodiments

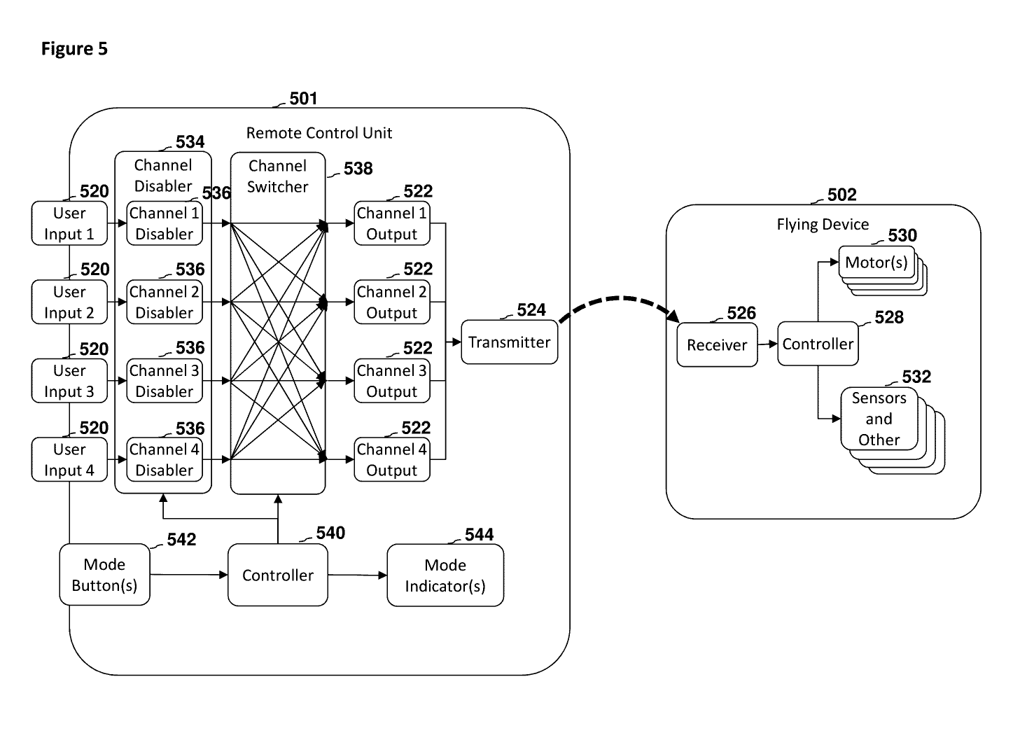

FIG. 5 illustrates another embodiment of a flying device 502, similar to the flying device 201 of FIG. 2A, that is controlled by a remote control unit 501, similar to the remote control unit 101 of FIG. 1A, having remappable or reconfigurable flight control channel outputs. In this embodiment, the flying toy 502 comprises a receiver 526, a controller 528, one or more motors 530, and/or one or more sensors and other components 532. The motors 530 may in some embodiments be motors that are directly driving propellers, such as in a typical drone, and/or may in some embodiments be servo motors or similar used to control one or more flight control surfaces, such as, for example, ailerons, rudder, elevator, and/or the like. The receiver 526 may be configured to receive a signal from the remote control unit 501, such as via wireless radio, infrared wireless, wired, and/or the like. The received signal may comprise flight control data that is interpreted by the controller 528 to enable the controller 528 to control the motors 530 and/or sensors and other components 532 to operate the flying toy 502. The flying toy 502 may be, for example, a helicopter, a quadcopter, and/or the like.

The remote control unit 501 comprises, in this embodiment, four input channels, similar to the remote control unit 101 of FIG. 1A. The remote control unit 501 comprises four user inputs 520, which may correspond to, for example, the four user input channels illustrated in FIG. 1A and may be associated with buttons, joysticks, and/or the like. The remote control unit 501 further comprises four flight control channel outputs 522. These flight control channel outputs 522 can be output to a transmitter 524 to transmit control signals to the flying toy 502.

In some embodiments, the remote control unit 501 may comprise more or fewer user input channels. For example, in some embodiments, the remote control unit 501 may comprise two, three, five, six, seven, eight, or more user input channels. Further, in some embodiments, the remote control unit 501 may comprise more or fewer flight control output channels. For example, in some embodiments, the remote control unit 501 may comprise one, two, three, five, six, seven, eight, or more flight control output channels.

The remote control unit 501 further comprises a controller 540 configured to control mapping of user input channels 520 to flight control output channels 522. For example, mode button or buttons 542, such as the buttons 106 and 108 of FIG. 1A, may be utilized to indicate to the controller 540 a desired operating mode for the remote control unit 501. The controller 540 may indicate the current mode by using one or more mode indicators 544, such as the speed indicator lights 116 described above.

The controller 540 may be configured to map user input channels to flight control output channels in various ways. In this embodiment, the remote control unit 501 comprises a channel disabler 534 and a channel switcher 538. The channel disabler 534 comprises individual channel disablers 536 that are capable of disabling or ignoring a particular user input channel. For example, if the remote control unit 501 were to be configured to operate similarly to the remote control unit 101 described above, putting the remote control unit 501 into a beginner or three channel mode would cause the channel 2 disabler 536 to disable user input channel 2 such that no flight control output is associated with user input channel 2. Further, the remote control unit 501 may be configured to switch individual user input channels to be mapped to a different flight control output channel using channel switcher 538. For example, if the remote control unit 501 is configured to operate similarly to the remote control unit 101 illustrated in FIG. 1A, in four channel or expert mode, the channel switcher 538 may be configured to enable each of the four user input channels 520 to pass directly through and output to their corresponding flight control output channel 522. However, when the remote control unit is put into beginner or three channel mode, the channel switcher 538 can be configured to remap user input channel 4 520 to flight control channel output number 2 522.

In some embodiments, the disabling, enabling, remapping, and/or the like of user input channels and/or flight control channels is performed at least partially or fully using hardware, such as, for example, relays, switches, and/or the like. In some embodiments, the disabling, enabling, remapping, and/or the like may be performed at least partially or fully in software.

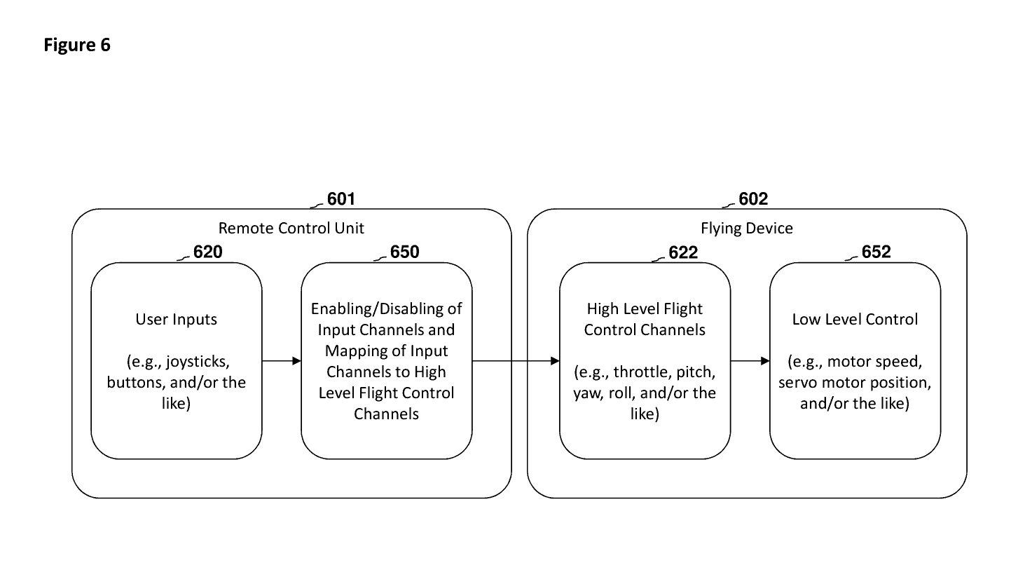

FIG. 6 illustrates a high-level block diagram of a remotely controlled flying device 602 that has reconfigurable or remappable flight control channels. In this embodiment, a remote control unit 601 is configured to control the flying toy 602. The remote control unit 601 comprises a plurality of user inputs 620, such as, for example, joysticks, buttons, and/or the like. The plurality of user inputs are configured to provide input to user input channels which may directly control one or more high level flight control channels, may indirectly control one or more high-level flight control channels, and/or may be disabled, remapped, and/or the like. At block 650, the remote control unit 601 can enable or disable one or more of the user input channels, and/or the remote control unit 601 may map or remap one or more of the user input channels to a high-level flight control channel. The flying toy 602 comprises a plurality of high-level flight control channels 622, such as throttle, pitch, yaw, roll, collective pitch, and/or the like. The flying toy 602 can be configured to convert inputs received from the remote control unit 601 comprising high-level flight control data into low-level control signals at block 652 that control the hardware of the flying toy 602, such as, for example, motors, servos, and/or the like.

The embodiment illustrated in FIG. 6 illustrates the channel enabling, disabling, and remapping functions being performed by the remote control unit 601. However, in other embodiments, the flying toy 602 may perform these functions, and the remote control unit 601 may simply pass along user input channels to the flying toy 602. Further, in this embodiment, the flying toy 602 performs the conversion from high-level flight control data into low-level control data. However, in other embodiments, the remote control unit may perform that function, and the remote control unit 601 may transmit data to the flying toy 602 that is configured to instruct a controller of the flying toy 602 in operating the low-level controls, such as motor speeds, servo positions, and/or the like.

In some embodiments, a remote control unit as disclosed herein is user configurable to enable a user to alter the way the user input channels and flight control channels are mapped within a particular control mode. In some embodiments, however, a remote control unit as disclosed herein does not comprise the ability for a user to edit or reconfigure the mappings and/or which channels are disabled in a particular control mode. In such an embodiment, for example, the remote control unit may comprise a button for each control mode (or a single button to cycle through two or more modes) that enables the user to set the current control mode of the remote control unit, but the remote control unit may not enable the user to reconfigure or edit the mappings of input and flight control channels within a particular control mode.

### Flying Device Embodiments

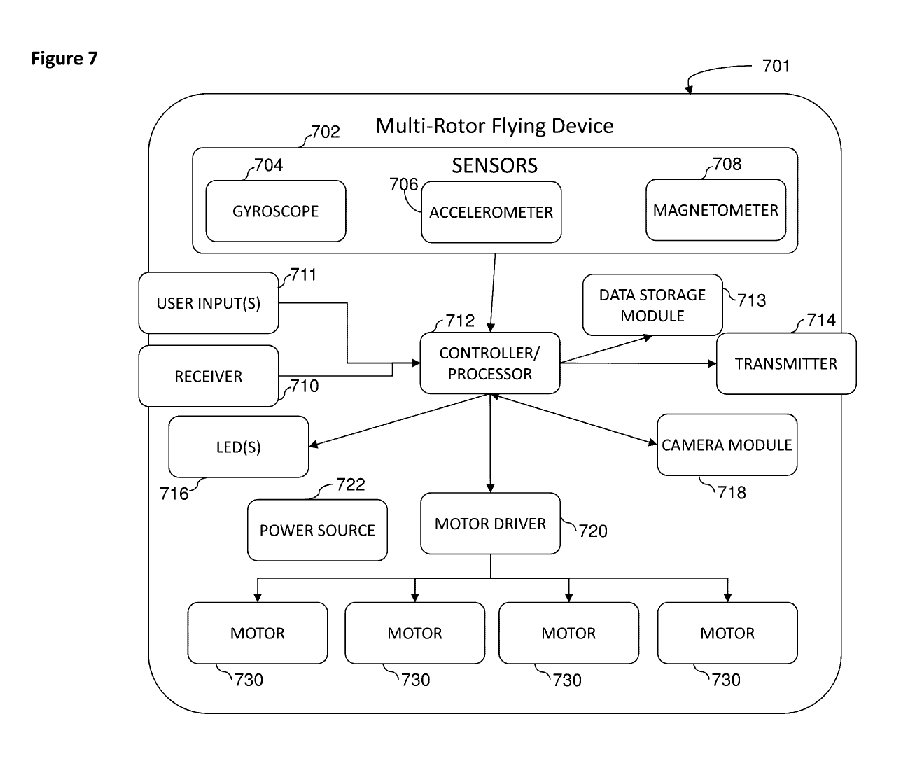

FIG. 7 illustrates an embodiment of a block diagram of a multi-rotor flying device, in this embodiment a quadcopter, which may be used with the techniques disclosed herein. Although this figure presents one embodiment of a flying device that can be used with the techniques disclosed herein, other embodiments of flying devices known in the art (for example, drones, helicopters, airplanes, and the like), and/or their associated remote control units, may be adapted to be used with the techniques disclosed herein. The multi-rotor flying device 701 comprises the following components: sensors 702; receiver 710; controller or processor 712; data storage module 713; transmitter 714; LED(s) 716; camera module 718; motor driver(s) 720; power source 722; and motor(s) 730. In other embodiments, a flying device may comprise fewer, greater, and/or different components.

The sensors 702 in the quadcopter 701 may comprise at least one or more of a gyroscope 704, accelerometer 706, magnetometer 708, and/or other sensors, such as GPS, thermometer, barometer, altimeter, camera (infrared, visual, and/or otherwise), and/or the like. The gyroscope sensor 704 allows for the calculation and measurement of orientation and rotation of the quadcopter 701. The accelerometer 706 allows for the calculation and measurement in acceleration of the quadcopter 701. The magnetometer 708 allows for the calculation and measurement of magnetic fields and enables the quadcopter 701 to orient itself in relation to various North, South, East, West directions. The quadcopter may use one or more of the described sensors to be functional and maintain flight. The acceleration and angular velocity, and other data, measured can be used by the quadcopter 701 to assist an operator in flight or record data that may be used for future flights and analysis, or the like. Other sensors may be implemented into the quadcopter 701 to measure and/or record additional statistics such as flight speed, battery level, servo motor position, or other data available through its sensors, internal components, and/or combination(s) of sensors and/or internal components.

The receiver 710 is configured to receive a signal from a remote control device. The signal may be sent via wireless radio, infrared wireless, wired, and/or the like. The received signal is then sent to the controller or processor 712 for processing and executing actions based on the received signal. Once the signal is processed, the controller 712 then send commands to the appropriate other components of the quadcopter 701. For example, the controller 712 may perform, among other things, conversion of high level flight control commands from the remote control device into low level motor control commands implement the desired flight control operations.

The system may also allow for users input(s) 711 to control various aspects or components of the system. For example, there may be one or more buttons, switches, microphones (for example, for auditory commands to be received by the user), or the like.

The data storage module 713 stores information and data. The data storage module 713 may comprise read-only memory for the processor 712 to execute previously programmed functions (for example, to turn the LED light on when the quadcopter is powered on). The data storage module 713 may also or alternatively comprise writeable memory to store various programmed functions, data received from the various sensors 702, and/or the like. The data storage module 713 need not contain both types of memory, and may in fact be two or more separate elements optionally implemented. For example, the read-only memory may be incorporated and no other writable memory may be provided. Alternatively, there may be no type of memory installed and any instructions may come directly from a controller. Alternatively, there may be read-only memory installed in the quadcopter 702 and the user may install a physical memory card or chip to store additional information, if the user wishes. The data or information that would get stored in the data storage module 713 could, for example, originate from the component that created the information and go through processing prior to being written to the writable memory.

The transmitter 714 may receive data from the processor to be configured into a signal to send externally to another device, such as a remote control, computer, or remote server for storage and/or analysis. Similar to the received signal through the receive 710 as explained above, the signal sent may be via wireless radio, infrared wireless, wired, and/or the like. Although in this embodiment there are separate components for sending and receiving information (for example, a receiver 710 and a transmitter 714), some embodiments may comprise more than one receiver and/or transmitter, and/or may comprise one or more transceivers, which both receives and transmits signals.

The LED(s) 716 may be installed on the quadcopter in various locations to either indicate to the user some information that may be relevant, either through color, blinking, or brightness (for example, which end of the quadcopter is the front versus the back), or solely for aesthetic reasons alone.

The camera module 718 is a device that can be used to generate picture or video data from the quadcopter 701 during flight. The picture or video data may then be transmitted via the transceiver 714 to an external device or server or even the remote control, or the data may be stored in the data storage module 713, or both. In either situation, the camera must send the generated data to the processor 712 first, before the data is sent to the data storage module 713 or transceiver 714.

The motor driver 720 is configured to receive instructions from the processor 712 which it then uses to control the throttle and speed of the various motors 730 connected to the quadcopter 702. There may be more than one motor driver controlling the motors, however, in the present embodiment, only one is illustrated. The motor(s) 730 are connected to the motor driver 720 and receive instructions to operate at various speeds.

The power source 722 is also included in the quadcopter 701 to power each individual component. Although no line is drawn on FIG. 7 from the power source 722, each component (for example, processor, camera module, and more) desirably connects either directly or indirectly to the power source 722. This can also be done by connecting some or all devices to a circuit, or motherboard, which may contain the processor 712, and which is then connected to the power source 722. The power source 722 may be a battery (for example, Lithium Ion or Lithium Polymer battery that may be recharged, regular batteries such as AAA or AA, and/or the like), or there may be alternative power provided through other means, such as a wired connection or solar, among others.

In some embodiments, the separate components of FIG. 7 may be combined into fewer components to achieve the same purpose. For example, as stated above, the transmitter 714 and receiver 710 may be combined into one component, such as a transceiver.

### Remote Control Signal Generation Through Transmission Based on User Input

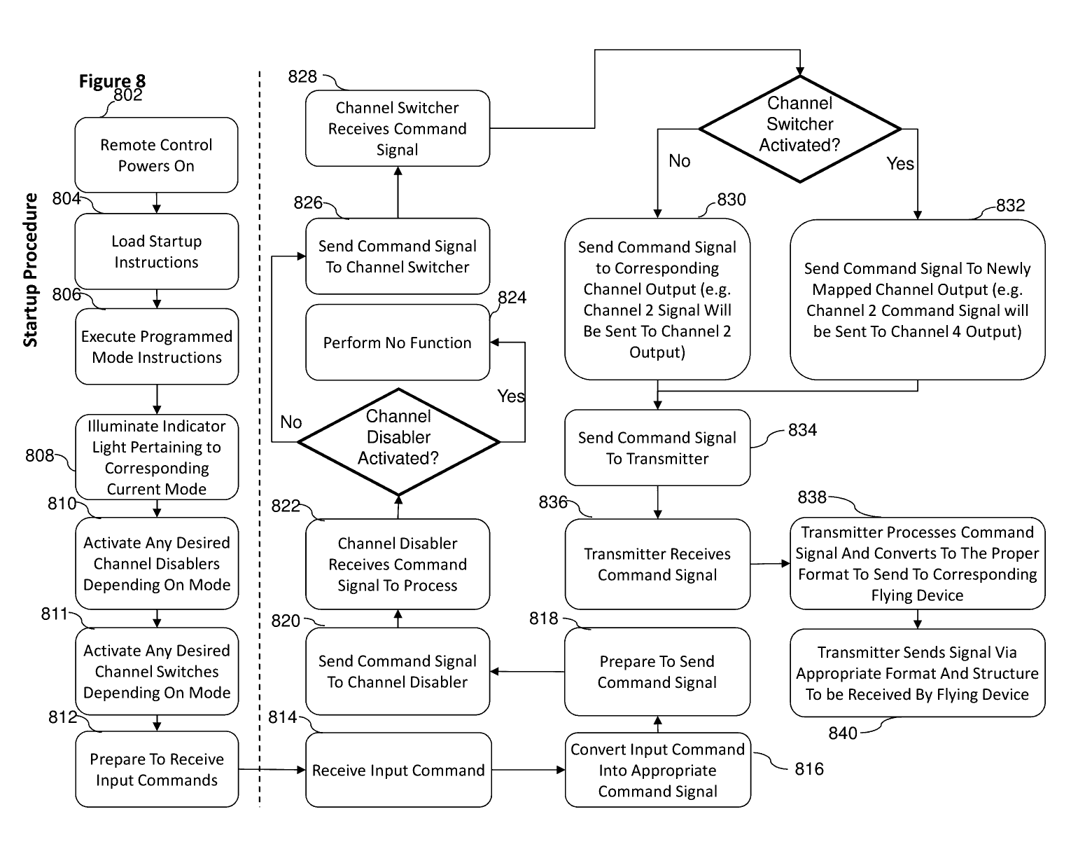

FIG. 8 illustrates a flow chart diagram of one embodiment of a process that a remote control unit can take in generating and transmitting a signal to a flying device using the techniques disclosed herein. Various other processes may also or alternatively be used. Many of the methods and systems described herein may produce the same results with either software programming, mechanical means, or through circuitry. It is not a requirement to use one means over another to achieve the same result. However, where one method is impractical, or not possible to implement without great expense, to one skilled in the art, then the more practical approach would be the preferred approach.

Blocks 802 through 812 pertain to a general startup procedure of the remote control unit. At block 802 the remote control unit powers on. This may be achieved by the user pressing a button, speaking a command (if a microphone is implemented in the device), flipping a switch, touching a sensor, based on pre-set conditions (for example, time or temperature), receipt of an “on” signal command from another device, or the like.

At block 804, the remote control unit loads any startup instructions required. In some embodiments there may be no startup instructions and the device is merely ready for input commands, or the device may load the startup instructions at a later point (either before or after an input is received by the user). Also, in in some embodiments, the loading of startup instructions may not be necessary, however, any equivalent startup instructions may be inherent in the configured elements within the device.

At block 806, the remote control unit executes any programmed mode instructions. In certain embodiments this may be either the three channel mode or four channel mode. In other embodiments the button mappings may also be variable. Whatever the configuration that is programmed in the initial mode, the instructions are executed and sent to a controller to configure the channel disablers and channel switcher accordingly.

At block 808, an indicator light pertaining to a corresponding mode may illuminate to indicate to the user what mode the device is currently in. In other embodiments the same could be indicated to the user through other means, such as a switch (for example, when the switch is set on three channel mode a colored sticker is visible, and when the user flips the switch to four channel mode the colored sticker may then be hidden and a new sticker of a different color may appear and be visible to the user to indicate that the four channel mode is activated), or through beeps. Providing an auditory notification can be provided either in tandem or by itself to indicate the same information to the user.

At block 810, the remote control unit will activate any channel disablers depending on the mode the remote control unit is set on. In some embodiments there may be no activation of any channel disablers, or the disablers may be implemented through other means. Also, in other embodiments, the device may activate any channel disablers at a later point (either before or after an input is received by the user). In four channel mode, no flight channel would be disabled. In three channel mode, however, one flight channel would be disabled as described above in this application.

At block 811, the remote control unit will activate any desired channel switches depending on the mode the remote control unit is set on. In some embodiments there may be no activation of any channel switches, or the switches may be implemented through other means. Also, in other embodiments, the device may activate any channel switches at a later point (either before or after an input is received by the user). In one example listed above in this application, three channel mode may comprise disabling user input channel 2 520 with a channel 2 disabler 536, and also activating the channel switcher 538 to configure the mapping of input channel 4 520 to channel 2 output 522 and input channel 2 520 (which is disabled) to channel 4 output 522, as shown in FIG. 5. The effect of this example would be for the horizontal channel (channel 2) to be deactivated on the remote control unit and input channel 4 would control the yaw of the corresponding flying unit. Further to the previous example, in other embodiments the input channel 2 520 does not necessarily need to be configured to be mapped to channel 4 output 522 to achieve the same result because the input channel is disabled.

At block 812, the remote control unit does any last required steps in order to prepare to receive an input command from the user. Steps may include anything necessary to function or the steps may be completely for user preference (for example, special lighting scheme or auditory confirmation that the device is ready).

At block 814, the remote control unit receives a command. The command received may be received through a physical touch by a user, or through any other means (for example, voice, or motion of the controller).

At block 816, the remote control unit will convert the received command into an appropriate signal. However the input command is received at block 814, the command may need to be converted into a proper signal for the system to complete processing and execution of the command. For example, in several embodiments, the command may need to be converted into an electrical signal.

At block 818, the remote control unit may need to prepare the signal prior to being sent. Preparation is optional in certain embodiments; however, it may be necessary or preferred in some embodiments depending on the remote control unit's configuration. For example, it might be more efficient (for example, to safe battery) to spool several signals prior to sending. Another example of why preparation may be implemented is to prioritize flight commands over other input commands, such as commands to activate the camera, so that the flying toy will remain responsive and be more likely to stay in flight.

At block 820, the command signal is sent to the channel disabler.

At block 822, the channel disabler receives the command signal. At this point, the channel disabler has already received instructions on whether it should be activated or not at block 810. If the channel disabler for the respective channel is activated proceed to block 824. At block 824, if the channel disabler is activated then the device will stop processing the signal and no function will be performed by the remote control unit. If the channel disabler is not activated, then proceed to block 826. At block 826, if no channel disabler is activated, then the command signal is sent to the channel switcher.

At block 828, the channel switcher receives the command signal from the channel disabler. At this point, the channel switcher has already received instructions on whether it should be activated or not at block 811. If the channel switcher is not activated then proceed to block 830. At block 830, there would be no switching of channels such that an input channel 2 signal will be sent to the channel 2 output, and the same for all other channels. If the channel switcher is activated, then proceed to block 832. At block 832, one or more of the channels may be configured to be mapped to a different output channel. For example, a channel 2 input channel command may be sent to channel 4 output.

At block 834, once the command signal reaches the channel output, it is then sent to the transmitter. At block 836, the transmitter receives the command signal.

At block 838, the transmitter performs any additional processing that may be necessary prior to sending the signal to a corresponding flying toy. Some processing may include changing the signal into a different format (for example, an electrical signal into a wireless or infrared signal). Also, processing may include some sort of encryption to prevent any intentional or unintentional interference of controlling the flying toy during flight.

At block 840, the transmitter then sends the processed signal via the appropriate format and structure to be received by the corresponding flying toy.

### Flying Toy Signal Receiving, Processing, and Executing

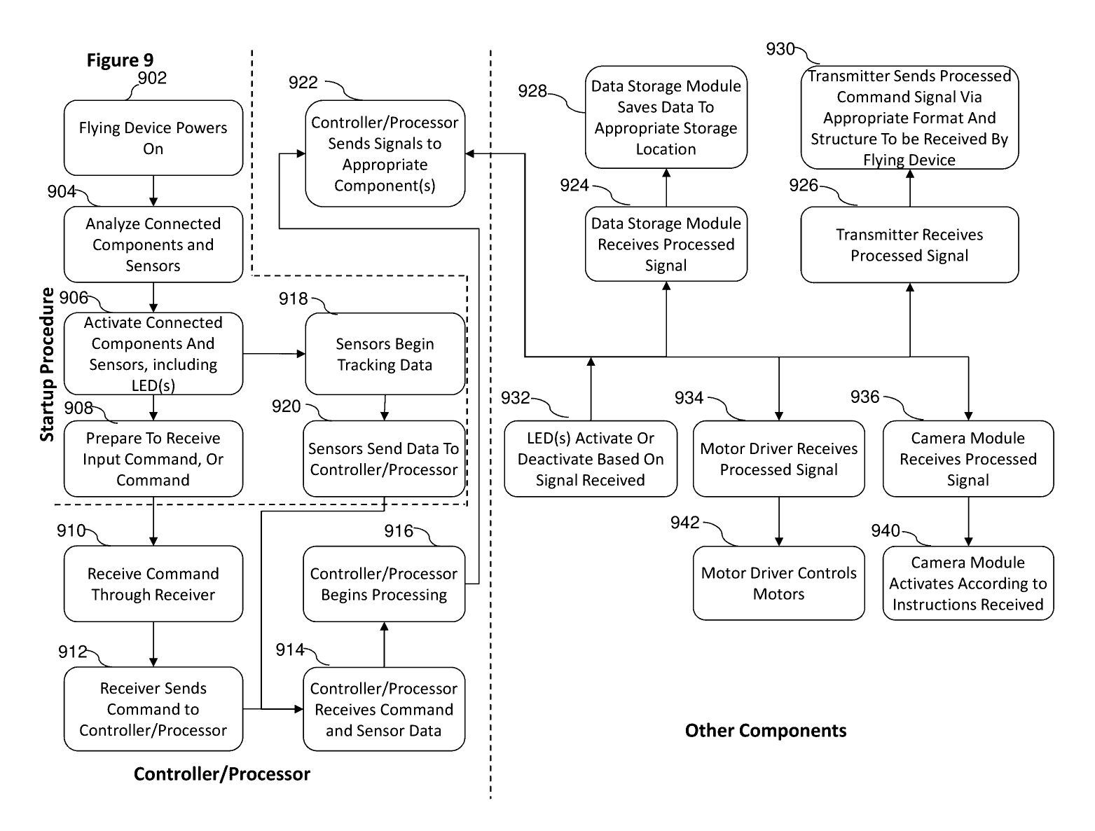

FIG. 9 illustrates a flow chart diagram of one embodiment of a process that a flying toy may take upon receipt to process and execute a signal. Many of the methods and systems described herein may produce the same results with either software programming, mechanical means, or through circuitry. It is not a requirement to use one means over another to achieve the same result. However, where one method is impractical, or not possible to implement without great expense, to one skilled in the art, then the more practical approach would be the preferred approach.

Blocks 902 through 908 pertain to a general startup procedure of the flying toy. At block 902 the flying toy powers on. This may be achieved by the user pressing a button, speaking a command (if a microphone is implemented in the device), flipping a switch, touching a sensor, based on pre-set conditions (for example, time or temperature), receipt of an “on” signal command from another device, or the like.

At block 904, the flying toy analyzes the connected components (either internal or external). The controller acknowledges which components are connected. Also, in some embodiments, the analysis of connected components may not be necessary; however, any equivalent analysis method may be inherent within the device (for example, the circuitry may be indicative of any connected components). Connected components may include sensors, cameras, microphones, speakers, receivers (for example, IR, radio, or the like), data storage modules (for example, internal memory or user input memory, such as an SD card), transmitter, motor driver, motors, LED(s), among others.

At block 906, the flying toy activates connected components. In some embodiments the flying toy may only activate the components that assist in flying to conserve power. For example, any external LED(s) may remain turned off until the user chooses. Another example would be to keep the camera turned off until the user chooses to activate it.

At block 918, the activated sensors begin tracking data in preparation for flight.

At block 920, the activated sensors begin to send data from tracking to the controller/processor.

At block 908, the flying toy does any last required steps in order to prepare to receive an input command from a remote control. Steps may include anything necessary to function or the steps may be completely for user preference (for example, special lighting scheme or auditory confirmation that the device is ready).

At block 910, the flying toy receives a command through its receiver. The command received may be received through a physical touch by a user, or through any other means (for example, voice, or motion of the controller).

At block 912, the receiver of the flying toy sends the received command to the controller or processor. In some embodiments, the flying toy will convert the received command into an appropriate signal. For example, in several embodiments, the command may need to be converted into an electrical signal.

At block 914, the controller in the flying toy receives the command and various sensor data.

At block 916, the controller in the flying toy processes the command and various sensor data. Processing may include analysis of the sensor data and command to send signals to the various components to either: activate, manipulate, or deactivate them. In some embodiments, data received by the controller may also then be written to memory in a data storage module (for example, an internal memory or user input memory, such as an SD card). Additionally, in some embodiments, the controller may also send data to a transmitter to be sent to an external device. Such data may be helpful for tracking, flight, or diagnostics (whether real-time or not).

At block 922, after processing completes, and if required, signals are sent to various components to either: activate, manipulate, or deactivate them. Not all components are necessarily communicated to at the same time. Such components may include, but are limited by: a data storage module, a transmitter, LED(s), a camera module, and a motor driver.

At block 924, the data storage module receives a processed signal from the controller. At block 926, the data storage module accordingly stores any information directed by the controller to the appropriate storage medium.

At block 928, the transmitter receives a processed signal from the controller. At block 930, the transmitter sends the processed signal after any further preparation that may be required. For example, in some embodiments, any sent signal may need to be formatted or converted to a different type of signal (for example, electrical to some type of wireless signal).

At block 932, any connected LED(s) may receive a processed signal from the controller will either activate or deactivate depending on the signal received and the current state of the LED (for example, whether the LED is currently activated or deactivated). For example, in some embodiments, the LED(s) may illuminate to show the user relevant information for flight (for example, the flying toy is powered on, or which direction is the front or back of the flying toy) or information unrelated to flight (for example, a light show for entertainment purposes).

At block 936, the camera module received a processed signal from the controller. At block 940, the camera module will activate according to the instructions received. This activation may involve some sort of picture or video recording. For example, the camera may snap 1 picture, a burst of pictures, record in slow-motion, or record regular video. The camera may also record or take pictures in varying resolution, or with other varying settings. In some embodiments, there may also be a preset default mode on how to take pictures or record video. The camera module, in some embodiments, may also send data back to the controller to either be saved in the data storage module and/or be transmitted externally via a transceiver.

At block 934, the motor driver receives a processed signal from the controller. In some embodiments, there may be only one motor driver, and in other embodiments there may be more than one. At block 942, the motor driver will activate and send a signal to specific motor(s) in the system. For example, a quadcopter would have four motors to be controlled and at least one will be sent a signal. The signal will force the connected motor(s) to either: turn on, change speed, or turn off. Several motors may receive the same or different signals at the same time. For example, in some embodiments, a change in throttle instruction for a quadcopter would provide the same signal to all motors so that the flying toy will increase in elevation. Also, in other embodiments, a change in pitch instruction for a quadcopter would provide a different signal to the two front motors than to the two back motors.

### Other Remarks

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the disclosures or claims.

In some embodiments, the techniques disclosed herein related to wireless control of a flying device and/or dynamic configurability of a controller are technically impossible to perform by a human being and/or require the use of a computing device. For example, to enable a reasonable level of controllability of the flying device, it can be desirable to reduce lag time or latency between movement of user inputs on the controller and corresponding flight control adjustments made by the flying device. It can be desirable for these adjustments to occur in real time or substantially in real time, such as, for example, with a lag time or latency of no greater than 1, 5, 10, 20, 50, or 100 milliseconds. Further, if a user wishes to switch the present control mode of the controller while the flying device is in flight, it can be desirable to minimize the amount of time it takes to switch modes, so that, for example, the flying device does not crash or otherwise operate undesirably while the mode switch is being made. This dynamic switch of modes can desirably occur in real time or substantially in real time, such as, for example, with a lag time or latency of no greater than 1, 5, 10, 20, 50, or 100 milliseconds.

The term, “Real-time,” can mean any time that is seemingly, or near, instantaneous such that a practiced user of a remote control unit, that is using such remote control unit to operate a flying toy, would be able to still fly the device. There is inherently a very small delay in the creation and transmission of a signal by a remote control unit added to another very small inherent delay in the receipt, processing, and execution of that received signal in a flying toy. The very small delay is typically a fraction of a second, but may even exceed a second in some circumstances. The delay may also depend on the physical properties of light or other physical phenomenon. The term, “Real-time,” encompasses all instances of delay to a point where a practiced user of a remote control unit can still maintain flight of a flying toy.

Any ranges disclosed herein also encompass any and all overlap, sub-ranges, and combinations thereof. Language such as “up to,” “at least,” “greater than,” “less than,” “between,” and the like includes the number recited. Numbers preceded by a term such as “approximately,” “about,” and “substantially” as used herein include the recited numbers, and also represent an amount close to the stated amount that still performs a desired function or achieves a desired result. For example, the terms “approximately”, “about”, and “substantially” may refer to an amount that is within less than 10% of, within less than 5% of, within less than 1% of, within less than 0.1% of, and within less than 0.01% of the stated amount.

Although the features that have been disclosed in the context of certain preferred embodiments and examples, it will be understood by those skilled in the art that the present disclosure extends beyond the specifically disclosed embodiments to other alternative embodiments and/or uses of the disclosure and obvious modifications and equivalents thereof. Additionally, the skilled artisan will recognize that any of the above-described methods can be carried out using any appropriate apparatus. Further, the disclosure herein of any particular feature, aspect, method, property, characteristic, quality, attribute, element, or the like in connection with an embodiment can be used in all other embodiments set forth herein. For all of the embodiments described herein the steps of the methods need not be performed sequentially. Thus, it is intended that the scope of the present disclosure herein disclosed should not be limited by the particular disclosed embodiments described above.

What is claimed is:

1. A dynamically configurable controller for wirelessly operating a flying device, the dynamically configurable controller comprising:
a housing sized to be held by a human hand;
a transmitter configured to transmit a control signal for receipt by the flying device, the control signal comprising data for operating a plurality of flight control channels of the flying device;
a plurality of input controls movably coupled to the housing and configured for manipulation by a user to control a plurality of input channels;
a computer processor configured to generate the control signal based at least in part on manipulations of the plurality of input controls; and
at least one control mode input configured to enable the user to switch the dynamically configurable controller between first and second control modes,
wherein, in the first control mode, the computer processor maps the plurality of input channels to the plurality of flight control channels using a first mapping, and
wherein, in the second control mode, the computer processor maps the plurality of input channels to the plurality of flight control channels using a second mapping different than the first mapping.

2. The multi-mode controller of claim 1, wherein the first mapping comprises associating each of the plurality of input channels with a corresponding flight control channel, and the second mapping comprises not associating at least one of the plurality of input channels with a corresponding flight control channel.

3. The multi-mode controller of claim 1, wherein the first mapping comprises associating a first input channel with a first flight control channel, and the second mapping comprises associating the first input channel with a second flight control channel.

4. The multi-mode controller of claim 1, wherein the first mapping comprises associating a first input channel with a first flight control channel and associating a second input channel with a second flight control channel, and the second mapping comprises associating the first input channel with the second flight control channel and not associating the second input channel with any flight control channel.

5. The multi-mode controller of claim 1, wherein the plurality of input controls comprises a control stick moveable in at least horizontal and vertical directions with reference to the housing, wherein movement in the horizontal direction is associated with a first input channel, and movement in the vertical direction is associated with a second input channel.

6. The multi-mode controller of claim 1, wherein at least one control mode input comprises at least one button.

7. The multi-mode controller of claim 1, further comprising:
a speed mode indicator configured to provide an indication to the user of a present speed mode of the controller,
wherein, in the first control mode, the speed mode indicator is configured to use a first method of providing the indication of the present speed mode, and
wherein, in the second control mode, the speed mode indicator is configured to use a second method different than the first method of providing the indication of the present speed mode.

8. The multi-mode controller of claim 7, wherein the speed mode indicator comprises a plurality of lights arranged in a line,
wherein the first method of providing the indication of the present speed mode comprises lighting one or more of the plurality of lights beginning at a first end of the line, and
wherein the second method of providing the indication of the present speed mode comprises lighting one or more of the plurality of lights beginning at a second end of the line.

9. A non-transitory computer-readable storage medium having an executable program stored thereon for causing a suitably programmed dynamically configurable controller to process by one or more processors computer program code by performing a method for wirelessly operating a flying device when the computer program code is executed by the dynamically configurable controller, the method comprising:
detecting a plurality of user inputs corresponding to movement of one or more input controls relative to a housing of the dynamically configurable controller, the controller comprising a plurality of input channels, and the plurality of user inputs each being associated with a respective input channel;
determining a present control mode of the dynamically configurable controller;
mapping the plurality of input channels to the plurality of flight control channels using a first mapping based on the determined present control mode;
generating a control signal comprising data for causing operation of the flying device, the control signal based at least in part on the mapping of the plurality of input channels to the plurality of flight control channels;
transmitting the control signal for receipt by the flying device;
detecting activation of a control mode input;
changing the present control mode of the dynamically configurable controller, responsive to detecting the control mode input; and
mapping the plurality of input channels to the plurality of flight control channels using a second mapping different than the first mapping, responsive to the change in present control mode.

10. The non-transitory computer-readable storage medium of claim 9, wherein the first mapping comprises associating each of the plurality of input channels with a corresponding flight control channel, and the second mapping comprises not associating at least one of the plurality of input channels with a corresponding flight control channel.

11. The non-transitory computer-readable storage medium of claim 9, wherein the first mapping comprises associating a first input channel with a first flight control channel, and the second mapping comprises associating the first input channel with a second flight control channel.

12. The non-transitory computer-readable storage medium of claim 9, wherein the first mapping comprises associating a first input channel with a first flight control channel and associating a second input channel with a second flight control channel, and the second mapping comprises associating the first input channel with the second flight control channel and not associating the second input channel with any flight control channel.

13. The non-transitory computer-readable storage medium of claim 9, wherein the one or more input controls comprises a control stick moveable in at least horizontal and vertical directions, wherein movement in the horizontal direction is associated with a first input channel, and movement in the vertical direction is associated with a second input channel.

14. The non-transitory computer-readable storage medium of claim 9, wherein the method further comprises:
indicating to the user a present speed mode of the controller, wherein, in a first control mode, the speed mode indicator is configured to use a first method of providing the indication of the present speed mode, and wherein, in a second control mode, the speed mode indicator is configured to use a second method different than the first method of providing the indication of the present speed mode.

15. The non-transitory computer-readable storage medium of claim 15, wherein the indication to the user of the present speed mode is performed by using a plurality of lights arranged in a line, wherein the first method of providing the indication of the present speed mode comprises lighting one or more of the plurality of lights beginning at a first end of the line, and wherein the second method of providing the indication of the present speed mode comprises lighting one or more of the plurality of lights beginning at a second end of the line.

16. A computer-implemented method of wirelessly operating a flying device using a dynamically configurable controller, the method comprising:
detecting a plurality of user inputs corresponding to movement of one or more input controls relative to a housing of the dynamically configurable controller, the controller comprising a plurality of input channels, and the plurality of user inputs each being associated with a respective input channel;
determining a present control mode of the dynamically configurable controller;
mapping the plurality of input channels to the plurality of flight control channels using a first mapping based on the determined present control mode;
generating a control signal comprising data for causing operation of the flying device, the control signal based at least in part on the mapping of the plurality of input channels to the plurality of flight control channels;
transmitting the control signal for receipt by the flying device;
detecting activation of a control mode input;
changing the present control mode of the dynamically configurable controller, responsive to detecting the control mode input; and
mapping the plurality of input channels to the plurality of flight control channels using a second mapping different than the first mapping, responsive to the change in present control mode.

17. The method of claim 16, wherein the first mapping comprises associating each of the plurality of input channels with a corresponding flight control channel, and the second mapping comprises not associating at least one of the plurality of input channels with a corresponding flight control channel.

18. The method of claim 16, wherein the first mapping comprises associating a first input channel with a first flight control channel, and the second mapping comprises associating the first input channel with a second flight control channel.

19. The method of claim 16, wherein the first mapping comprises associating a first input channel with a first flight control channel and associating a second input channel with a second flight control channel, and the second mapping comprises associating the first input channel with the second flight control channel and not associating the second input channel with any flight control channel.

20. The method of claim 16, wherein the one or more input controls comprises a control stick moveable in at least horizontal and vertical directions, wherein movement in the horizontal direction is associated with a first input channel, and movement in the vertical direction is associated with a second input channel.
